(19) United States
(12) Patent Application Publication
(10) Pub. No.: US 2024/0240771 A1
(43) Pub. Date: Jul. 18, 2024

(54) VEHICLE LIGHT BAR WITH IMPROVED HEAT DISSIPATION FINS

(71) Applicant: Hopkins Manufacturing Corporation, Emporia, KS (US)

(72) Inventors: Chris Connington, Long Grove, IL (US); Iqbal Singh, Buffalo Grove, IL (US); Eric Li, Enping City (CN)

(21) Appl. No.: 18/414,941

(22) Filed: Jan. 17, 2024

Related U.S. Application Data
(60) Provisional application No. 63/480,128, filed on Jan. 17, 2023.

(51) Int. Cl. F21S 45/48; F21V 29/74

(52) U.S. Cl. CPC F21S 45/48; F21V 29/74

(57) ABSTRACT

A vehicle light bar that effectively dissipates excess heat without creating unwanted vibrations and noises is disclosed. The light bar includes a number of lights and lenses as well as associated power and control components mounted in or on a housing and a number of heat dissipation fins extending from the housing. The fins are relatively short, thick, and closely spaced and do not vibrate and create noticeable noises even when the vehicle to which the lightbar is attached is travelling at high speeds.

### RELATED APPLICATIONS

The present non-provisional patent application claims priority benefit with regard to all common subject matter of prior-filed U.S. provisional patent application Ser. No. 63/480128, filed Jan. 17, 2023, titled VEHICLE LIGHT BAR WITH IMPROVED HEAT DISSIPATION FINS. The above-referenced prior-filed patent application is hereby incorporated by reference into the present patent application in its entirety.

### BACKGROUND

Light bars and other auxiliary lighting systems are often installed on vehicles to provide additional lighting. Conventional light bars include a number of LEDs or other light sources and lenses for focusing the lights.

The light sources and their corresponding circuits generate heat that must be dissipated. A common way to passively dissipate excess heat is with heat dissipation fins extending from the housings of the lightbars.

As shown in the attached FIG. 6, conventional vehicle light bars include tall, slender heat dissipation fins A. The fins are designed this way to increase their surface areas and therefore dissipate more heat to the surrounding environment. But these relatively tall and slender fins vibrate and make noise when the vehicles to which they are attached are driven at high speeds. The vibrations can damage the lightbars and loosen mechanical and electrical connections, and the noises can be distracting to the vehicles' drivers and interfere with the drivers' hearing of audio systems and emergency vehicle sirens.

### SUMMARY

The present invention solves the above-described problems and related problems by providing a vehicle light bar that more effectively dissipates excess heat without creating unwanted vibrations and noises. An embodiment of the light bar includes a housing and a number of lights, lenses, and associated power and control components mounted in or on the housing. To dissipate heat generated by the lights, the light bar also includes a number of heat dissipation fins extending from the housing. The fins are relatively short, thick, and closely spaced and do not vibrate and create noticeable noises even when the vehicle to which the light bar is attached is travelling at high speeds. In some embodiments, the housing also includes one or more interior air channels for passing cooling air through the housing and a number of heat dissipating fins extending into the air channel(s) to further increase heat dissipation from the light bar. In some embodiments, fins of different sizes are strategically positioned on the light bar to maximize heat dissipation and minimize vibrations and noise.

This summary is provided to introduce a selection of concepts in a simplified form that are further described in the detailed description below. This summary is not intended to identify key features or essential features of the claimed subject matter, nor is it intended to be used to limit the scope of the claimed subject matter. Other aspects and advantages of the present invention will be apparent from the following detailed description of the embodiments and the accompanying drawing figures.

### BRIEF DESCRIPTION OF THE DRAWING FIGURES

Embodiments of the present invention are described in detail below with reference to the attached drawing figures, wherein:

FIG. 1 is a perspective view of a light bar constructed in accordance with an embodiment of the present invention shown installed on a vehicle.

FIG. 2 is an exploded, fragmentary, perspective view of the light bar with one of its end caps removed.

FIG. 3 is an exploded, fragmentary, perspective view of a light bar constructed in accordance with another embodiment of the invention with one of its end caps removed.

FIG. 4 is a vertical sectional view of the housing of the light bar shown in FIG. 2.

FIG. 5 is a vertical sectional view of the housing of the light bar shown in FIG. 3.

FIG. 6 is a partial perspective view of a prior art light bar.

The drawing figures do not limit the present invention to the specific embodiments disclosed and described herein. The drawings are not necessarily to scale, emphasis instead being placed upon clearly illustrating the principles of the invention.

### DETAILED DESCRIPTION

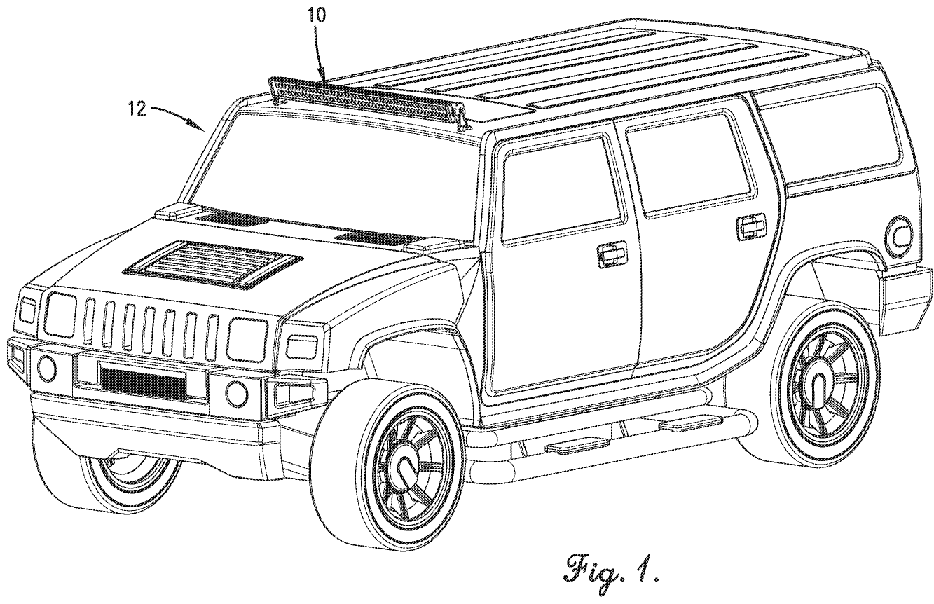

A vehicle light bar 10 constructed in accordance with embodiments of the present invention is shown in the attached Figures. As shown in FIG. 1, the vehicle light bar 10 may be mounted on a roof or other part of a truck or other vehicle 12.

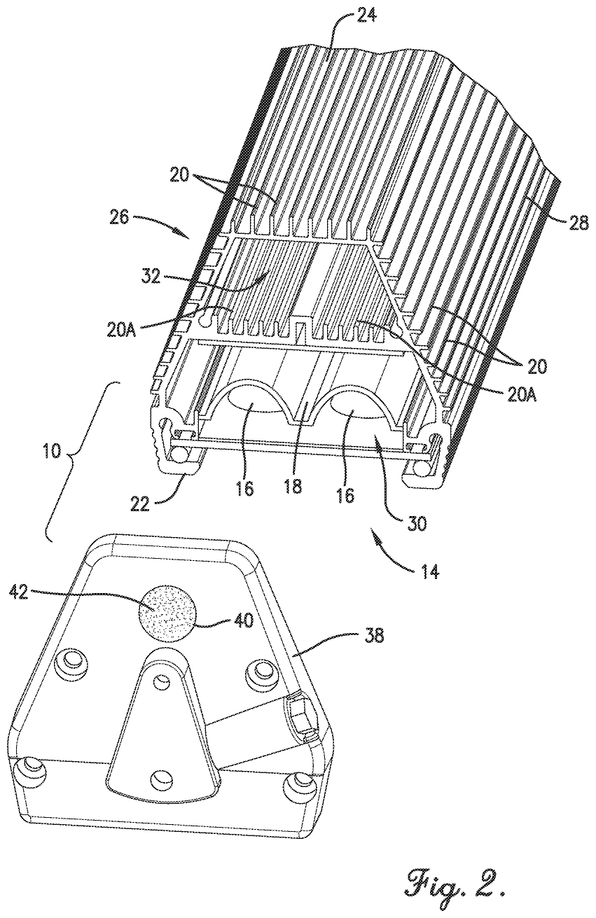

Referring now to FIG. 2, embodiments of the light bar 10 comprise a housing 14 and number of lights 16, lenses 18, and associated power and control components mounted in or on the housing 14. As explained in more detail below, the light bar 10 also includes a number of heat dissipation fins 20 extending from the housing 14 and sized and arranged to more effectively dissipate excess heat from the light bar without creating unwanted vibrations and noises.

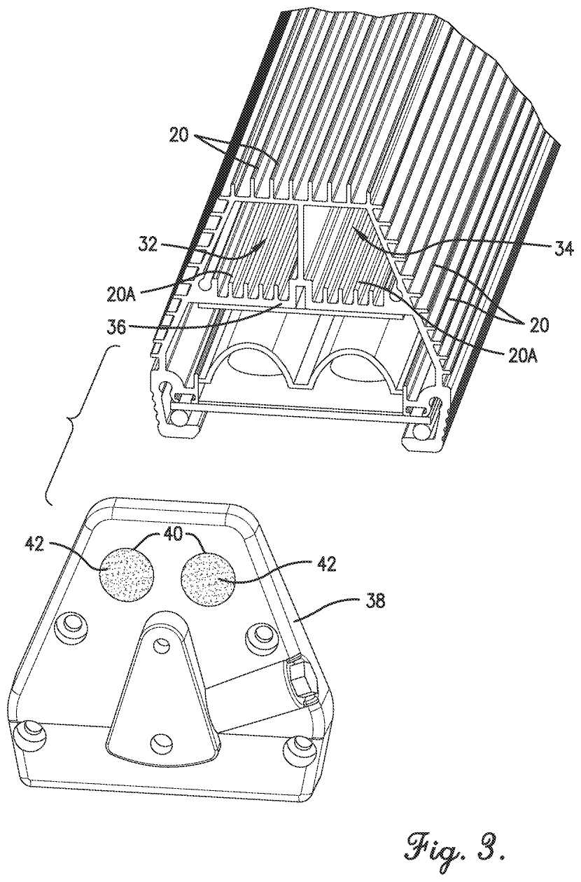

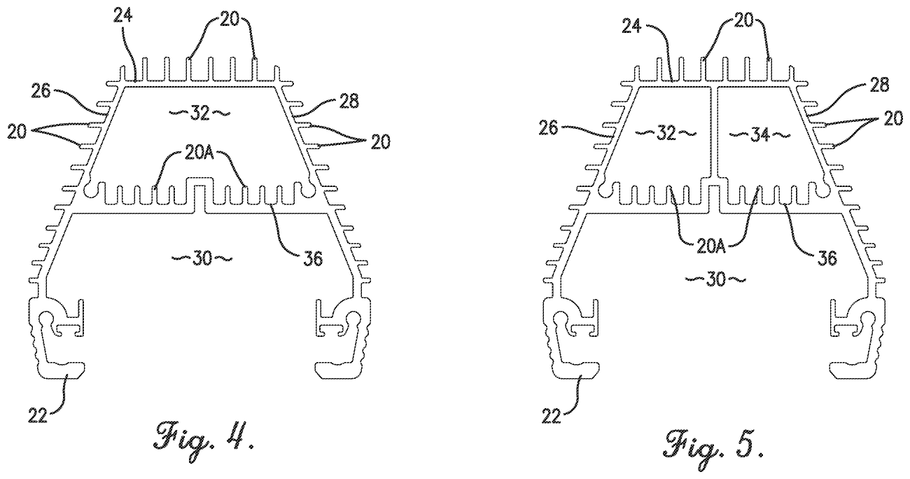

The housing 14 may be any shape and size and made of any suitable materials and has an exterior front wall 22, an exterior rear wall 24, an exterior top wall 26, and an exterior bottom wall 28. An embodiment of the housing is hollow and includes an interior light channel 30 in which the lights 16 are mounted and one or more interior air channels for directing air flow through the housing. The embodiment of the light bar shown in FIGS. 2 and 4 includes one interior air channel 32, and the embodiment of the light bar shown in FIGS. 3 and 5 includes a space divided into two interior air channels 32, 34. Each interior air channel has an interior front wall 36 proximate the interior light channel 30 and the lights 16 mounted therein.

The light bar 10 may also include end caps 38 that cover the open ends of the housing and the interior light channel 30 and the interior air channels 32, 34. The end caps 38 may include air orifices 40 with air permeable filters/breathers 42 to let air in and out of the air channels while limiting water intrusion into the air channels.

The lights 16 and lenses 18 are conventional and are mounted in the interior light channel 30 so as to direct light out the exterior front wall 22 of the housing. In one embodiment, the lights 16 are light emitting diodes (LEDs).

Turning now to FIGS. 4 and 5, the heat dissipation fins 20 will now be described in more detail. In accordance with an important aspect of the invention, the heat dissipation fins 20 are sized, configured, and arranged to effectively dissipate excess heat from the light bar 10 without creating unwanted vibrations and noises when the vehicle 12 to which the light bar is attached is travelling at high speeds.

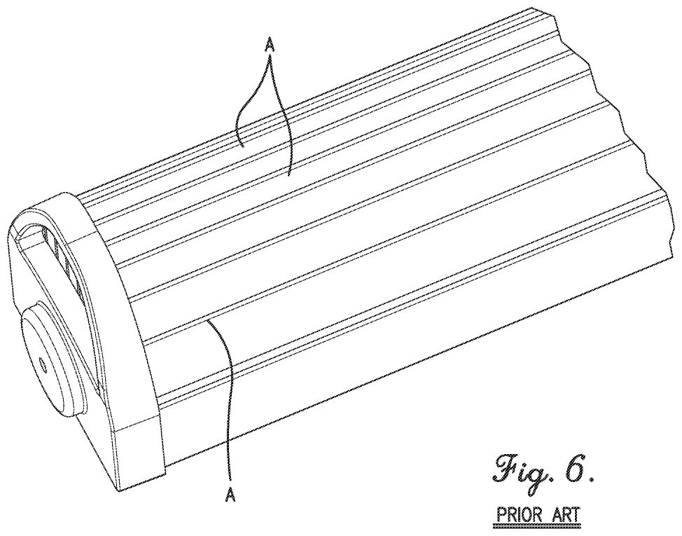

In one embodiment of the light bar, a number of the heat dissipation fins 20 extend from the exterior rear wall 24, the exterior top wall 26, and the exterior bottom wall 28 of the housing. The fins 20 are relatively short and thick when compared to the prior art fins shown in FIG. 6. These shorter and thicker fins 20 do not vibrate and create noticeable noises even when the vehicle to which the lightbar 10 is attached is travelling at high speeds.

In one embodiment, each fin 20 has a height no more than twice its thickness. In another embodiment, each fin has a height no more than three times its thickness. In yet another embodiment, each fin has a height no more than four times its thickness. In yet another embodiment, each fin has a height no more than five times its thickness.

In some embodiments, each fin is between 1/16-½ inches tall and 1/32-¼ inches thick. In some embodiments, all the fins 20 are the same height and thickness. In other embodiments, some of the fins are taller than others. For example, the fins on the exterior rear wall 24 of the housing may be taller than the fins on the top and bottom walls 26, 28 of the housing. Taller fins on the exterior rear wall 24 are less likely to vibrate because the housing shields them from air flowing over the housing.

To provide adequate heat dissipation with shorter fins 20, the fins are closely spaced so that more fins can be formed on the housing as compared to the prior art fins shown in FIG. 6. The greater number of fins together have a cumulative surface area similar to or even greater than the cumulative surface area of prior art light bar fins. In one embodiment, the lightbar includes 20--40 fins on the exterior of the housing that are spaced 1/32-½ inches apart.

To further increase heat dissipation, embodiments of the light bar may include heat dissipating fins 20A in the air channels 32, 34. The fins 20A preferably extend from the interior front wall so as to dissipate heat from the adjacent light channel. In one embodiment, the lightbar includes 5-20 fins 20A in the air channels. In some embodiments, the fins 20A are the same height and thickness as the fins 20 on the exterior of the housing. In other embodiments, the fins 20A are taller or shorter than the fins 20. For example, the fins 20A may be shorter than the fins 20 on the rear wall of the housing but the same height as the fins 20 on the top and bottom walls of the housing. The fins 20A may be spaced 1/32-½ inches apart.

### ADDITIONAL CONSIDERATIONS

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments but is not necessarily included. Thus, the current technology can include a variety of combinations and/or integrations of the embodiments described herein.

Although the present application sets forth a detailed description of numerous different embodiments, the legal scope of the description is defined by the words of the claims set forth in any related utility patents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

The patent claims at the end of this patent application are not intended to be construed under 35 U.S.C. § 112(f) unless traditional means-plus-function language is expressly recited, such as “means for” or “step for” language being explicitly recited in the claim(s).

Although the invention has been described with reference to the embodiments illustrated in the attached drawing figures, it is noted that equivalents may be employed and substitutions made herein without departing from the scope of the invention as set forth in the claims below.

Having thus described various embodiments of the invention, what is claimed as new and desired to be protected by Letters Patent includes the following:

1. A vehicle lightbar comprising:
a housing;
a plurality of lights mounted in or on the housing; and
a plurality of heat dissipation fins extending from the housing, each fin having a height and a thickness, with the height being no greater than five times the thickness.

2. The vehicle lightbar of claim 1, wherein each fin is between 1/16-½ inches tall and 1/32-¼ inches thick.

3. The vehicle lightbar of claim 1, wherein some of the fins are taller than other fins.

4. The vehicle lightbar of claim 1, wherein the housing has an exterior front wall, an exterior rear wall, an exterior top wall, and an exterior bottom wall, and wherein the fins extend from the exterior rear wall, the exterior top wall, and the exterior bottom wall.

5. The vehicle lightbar of claim 4, wherein the fins extending from the exterior rear wall of the housing are taller than the fins extending from the exterior top wall and the exterior bottom wall of the housing.

6. The vehicle lightbar of claim 1, wherein the fins are spaced no more than ¼ inches apart.

7. The vehicle lightbar of claim 1, wherein the housing is hollow and includes an interior light channel in which the lights are mounted and an interior air channel for directing air flow through the housing.

8. The vehicle lightbar of claim 7, wherein the interior air channel has an interior front wall and a plurality of heat dissipation fins extending from the interior front wall.

9. The vehicle lightbar of claim 8, wherein the fins extending from the exterior rear wall of the housing are taller than the fins extending from the interior front wall of the interior air channel.

10. The vehicle lightbar of claim 7, wherein the housing further includes a pair of end caps for closing ends of the interior light channel and the interior air channel.

11. The vehicle lightbar of claim 7, wherein the end caps each include a window and a filter positioned in the window to let air in and out of the interior air channel but prevent water intrusion into the interior air channel.

12. A vehicle lightbar comprising:
a housing including an exterior front wall, an exterior rear wall, an exterior top wall, and an exterior bottom wall;
a plurality of lights mounted in or on the housing; and
a plurality of heat dissipation fins extending from the exterior rear wall, the exterior top wall, and the exterior bottom wall of the housing, wherein the fins extending from the exterior rear wall of the housing are taller than the fins extending from the exterior top wall and the exterior bottom wall of the housing.

13. The vehicle lightbar of claim 12, wherein each fin is between 1/16-½ inches tall and 1/32-¼ inches thick.

14. The vehicle lightbar of claim 12, wherein the fins are spaced no more than ¼ inches apart.

15. The vehicle lightbar of claim 12, wherein the housing is hollow and includes an interior light channel in which the lights are mounted and an interior air channel for directing air flow through the housing.

16. The vehicle lightbar of claim 15, wherein the interior air channel has an interior front wall and a plurality of heat dissipation fins extending from the interior front wall.

17. The vehicle lightbar of claim 16, wherein the fins extending from the exterior rear wall of the housing are taller than the fins extending from the interior front wall of the interior air channel.

18. The vehicle lightbar of claim 15, wherein the housing further includes a pair of end caps for closing ends of the interior light channel and the interior air channel.

19. The vehicle lightbar of claim 18, wherein the end caps each include a window and a filter positioned in the window to let air in and out of the interior air channel but prevent water intrusion into the interior air channel.

20. A vehicle lightbar comprising:
a housing including an exterior front wall, an exterior rear wall, an exterior top wall, and an exterior bottom wall and an interior air channel;
a plurality of lights mounted in or on the housing;
a plurality of heat dissipation fins extending from the exterior rear wall, the exterior top wall, and the exterior bottom wall of the housing; and
a plurality of heat dissipation fins in the interior air channel.

21. The vehicle lightbar of claim 20 wherein each fin of the plurality of heat dissipation fins extending from the housing and in the interior air channel have a height and a thickness.

22. The vehicle lightbar of claim 21 wherein the height of each fin is no greater than five times the thickness of each fin.
